(19) United States
(12) Patent Application Publication
(10) Pub. No.: US 2018/0122275 A1
(43) Pub. Date: May 3, 2018

(54) LED Display Fund-raising and alert and Warning System

(71) Applicants: Charles J. Freels, Woolwines, VA (US); Judith Ann Freels, Woolwine, VA (US); Charles Clifton Freels, Woolwine, VA (US); Brandi Gretchen Freels, Woolwine, VA (US)

(72) Inventors: Charles J. Freels, Woolwines, VA (US); Judith Ann Freels, Woolwine, VA (US); Charles Clifton Freels, Woolwine, VA (US); Brandi Gretchen Freels, Woolwine, VA (US)

(73) Assignee: Judith Ann Freels, Woolwine, VA (US)

(21) Appl. No.: 15/154,726

(22) Filed: May 13, 2016

(51) Int. Cl. G09F 9/33; G08B 5/22

(52) U.S. Cl. CPC G09F 9/33; G08B 5/22

(57) ABSTRACT

A) Software development allowing special formatting on LED Display signage for ‘Sponsorship’ acknowledgements)
Advantage: Ease of use with allowing non-tech savvy Users quickly enter in Sponsor's information with pre-established formatted screens.
Advantage: This is extremely beneficial to the Agencies in the regard that the Agencies will now have a rather effortless method of raising funds, especially when concerning budget cuts and suspension of grants are more prevalent.
Advantage: This will stimulate use and bring about a higher calling for what traditional LED Display signage is used for.

B) Local 911 Connection to individual LED Display or Group of LED Displays enabling Instant awareness capabilities
Advantage: The 911 Command Centers have instant access to locate the area and LED display within their respective area of coverage and will provide nearly instant important information. The technology allows even non-tech savvy Users to easily and quickly send out warning or awareness to relevant areas; making for instant and timely awareness.
Advantage: Ease of use allowing non-tech savvy Users quickly enter in geographically relevant information with pre-established formatted screens.
Advantage: Localities can utilize this Tool for help with their Disaster Plans and Evacuation Routes.
Advantage: If an existing ThinkSign LED sign holder has the desire to have their existing sign commandeered by the 911 Command Center, they can upgrade their system to utilize this function.
Advantage: Highways can use this as a better communication tool especially regarding warning and alerts that require visual graphics (i.e.: Pictures) and to help cut costs within the D.O.T. organizations.
   Software development allowing relevant 911 warnings and alerts (awareness alerts/updates) with a split screen for warnings/alerts to stay stagnant during rotating Sponsorship and Community information.
Advantage: Ease of use allowing not-tech savvy users to quickly enable two massages at a time. For instance, one side displaying a warning, alert or awareness update, while sponsor information, and the pre-loaded program that the Agency was already running, rotates on the other side.
Mobile Device Application through the Mobile Device Application, which can also be accessed through the “911 ThinkSign” Main Website; there will be a Mobile application that will enable push notification as you travel based on your GPS location. The notifications will keep applicants informed of severe weather alerts (i.e.: tornados, snow, flood, ice, etc. . . . ), Police Emergency notifications (i.e.: Amber Alerts, escaped convicts, accident notifications etc. . . . ), Road Closings (per the Department of Transportation(s)), Offenders (i.e.: sex offenders, most wanted etc. . . . ) and other important information.
Advantage: Individuals can be kept informed so they can respond quicker to situations that may arise as they travel. This will help lower incidents and lower 911 Agencies needing to respond.
Advantage: By raffling off after 5 years. The agencies are able to stay up to date with the latest technology.

F) Portal for software design issues; chatting, video conferencing, and troubleshooting submitting
Advantage: This will enable SaaS and other software programs instant software upgrades and downloads every time user logs on, instant access to trouble shoot the sign, chatting, and video conferencing via the Cloud, allowing for Optimized assistance over traditional methods to save time. Also allowing ‘Screen Sharing’ opportunities so that the Technician can see what the issue is firsthand.

G) Portal for On-Site Warranty; chatting, video conferencing, and troubleshooting submitting
Advantage: This will all be done through ThinkSign and with their technicians. The Agencies will not have to get involved with repairs. This will enable instant chatting, video conferencing and trouble shooting, via the Cloud by issuing individual IP address, allowing the Agencies to cut down on time which could be wasted having to use traditional attempts to secure help. Also allowing ‘Screen Sharing’ opportunities so that the Technician can see firsthand issue that the User is having.

H) Implementation of LCD Monitors for Training and Bay area use(s)
Advantage: This will provide a proper training tool to use during Training by use of SaaS
Advantage: LCD Monitors can also be utilized in the Bay areas so that the 911 Control Center can send the information in text form thru the cloud using another IP address. This can be implemented in all departments especially in underfunded and rural areas.

I) SaaS Capability with updating capabilities for training purposes within 911 Agencies.
Advantage: This will enable Agencies to be connected to their individual training needs and requirements, but more importantly it will be current up-to-date information and enable them to enact the new requirements when they are mandated.
Also establish a notice system which will enable the SaaS companies to email Members/Users with any updated information that will enable Users to stay current with all information.

J) Leasing Portal within Cloud will allow easy applications for large purchases
Advantage: This will have Leasing/Finance companies who are specialists in the Agencies fields, which will allow quicker processing of small or large equipment needs so that the Agencies can move swiftly on their procurement needs.

K) Corporate Sponsors within the Cloud will provide Agency specific discounts, with easy access portals for purchases.
Advantage: The costs that the Corporate Sponsors will pay to be on this Cloud, will enable the Cloud to run smoothly, and up-to-date, which will enable the Agencies costs to stay low and their information that they retrieve from the Cloud to be timely. Also, the end users can approach corporate sponsors for sponsorship of their displays.
Advantage: Allow/Provide the Corporate Sponsors to have portals into their sites for streamlined procurement opportunities and easily offer Discounts to Agencies.

L) Website Sponsor pages:
Advantage: A preformatted designed website page which can be easily duplicated so that the Agencies can add this page onto their website enabling the Community to easily go to the Agencies Website to locate their individual Sponsors.
Advantage: The Community of the Agency that adopts the Program can easily access the sponsors that are supporting their own community. Sponsors will obtain Good Will within their local communities, which will stimulate their sales.
Mobile Device Application and through the Mobile Device Application, which can also be accessed through the “911 ThinkSign” Main Website, will also have the capability to enter in a City/State or Zip Code of a desired area. This will populate and display all of the relevant LED Displays of all of the Agencies involved in this program in that area. At that point the application user can choose to go into the desired website of the Agency, go to the page that contains the spooler for the Agencies LED Displays and quickly view the contents that are presently being displayed on the Agencies LED Displays. All of this will be incorporated to have savable (city/Locations, etc. . . . ) features with multiple options to choose from.
Advantage: As individuals travel, they can have access to the local towns, cities etc. . . . that they travel through to see what is going on enabling them to participate in otherwise difficult activates to find out about. They can also do a search that will let them research local towns, cities etc. . . . that they may be traveling to in the near future, enabling them to make better plans to participate in local activities further adding to the fund raising opportunities for the Agencies.
Screen Saver Option. The Agency's will have a page that will have the LED Display content of their specific LED Display converted to a typical screen saver that any individual can choose to select and have display on their computer, T.V. (monitor, display etc. . . . ) or mobile device.
Advantage: This will give individuals of local areas the accessibility and novelty to have their area's (or whatever area they choose) LED Display to be shown on any computer, TV or (as technology provides) mobile device they would like.

C) Library of pre-designed video files (in all formats such as AVI files etc. . . . )
Advantage: This will further diminish time spent with running this Turnkey system. There will be a large, ever growing, Library of predesigned Graphics, messages etc. . . . (Graphics) that the User will be able to drag and drop into their LED Display. The Graphics will be formatted so no matter what pixel the LED Display, the program will immediately read the specific Display that the User is programming, and it will quickly change to meet the Display Specifications and pixels.

D) Bulletin Board Forum in the Cloud
Advantage: This will enable the Agencies to Post Wants, Needs, Items for Sale, and Free materials for other Agencies to easily access, (etc. . . . ) which will eliminate the need for costly advertising to the general public where there is a less of need for their particular type of equipment (such as Hoses, turn out gear, air packs, holsters, stretchers, Ambulances, Fire trucks etc. . . . )

E) Rattle Independent Judging Program (RIJP)
Advantage: This is part of the program that will be a free service to the Agencies. In some instances, (depending on the condition of the existing sign) it can be used as an immediate Fund Raiser. RIJP can be used as a second opportunity for a Fund Raiser as well; for raffling off the LED Display they purchase at the beginning of this program after 5 years, enabling to have the additional Fund Raising money plus enabling them to update their LED Display to a more technically advanced model.
Advantage: It will provide an Independent Judging platform that the Agencies can use.
Advantage: Providing an opportunity for local business to win a sign through an affordable vehicle¹⁷.
Advantage: Providing an opportunity for local business to win Community recognition.

### BACKGROUND

Presently LED Displays are used by for-profit business settings for their individual advertising needs etc. . . . , or in non-profit organizations for typical information. Most Departments of Transportation do use a very large pixel LED Display that is just text oriented and is not capable of displaying legible graphics/photos.

Software to program the LED Displays is not used in a beneficial way for Non-Profit 501C Organizations and Government Agencies (collectively called Agency/Agencies) for the use of fundraising and in Alerts and Warnings within small Communities. Nor is a system implemented that will best help these Agencies with fundraising, or with providing unique alerts and warning in a more community based setting. Further, LED Manufacturers have not implemented the use of a Cloud-based software program involving the needs we have addressed here within. As such a new system to address fundraising and Alerts and Warnings with the use of a full color LED Display are presented herein.

During the process of our Utility Provisional Patent period, we have found two necessary benefits that we would like to add to our original Provisional Patent {61/992,584} {May 13, 2014} and Request for the extended missing part Pilot Program.

### THE PROBLEM

The problem within the Non-Profit 501C Organizations is that they are having a harder time with sustaining themselves financially due to Budge cuts and decreases in the private sectors donations and poor fundraising due to low attendance. This is all stemming from the poor economy.

The second problem is poor communication to the smaller communities before, during and after emergency situations.

New Revised Problem that has been isolated is that there is poor Data collection capabilities to sufficiently have the nonprofit organizations move forward with future responsive actions.

### BRIEF DESCRIPTION OF THE DRAWINGS AND ATTACHMENT

FIG. 1 is a perspective view of a diagram of the Cloud Program of exemplary versions of the present invention; Further: FIG. 1 is the revised perspective view of a diagram of the Cloud Program of exemplary versions of the present invention;

FIG. 2 is a perspective view of a typical Sponsor Screen of exemplary versions of the present invention;

FIG. 3 is a perspective view of an Urgent Warning Screen of exemplary versions of the present invention that will be provided through the FEMA IPAWS OPEN system;

FIG. 4 is a perspective view of a Missing & Exploited Children Amber Alert Screen with the use of a full color graphic of missing person of exemplary versions of the present invention on a typical full color LED Display;

FIG. 5 is a perspective view of a Missing & Exploited Children Amber Alert Screen with the use of a full color graphic of missing person of exemplary versions of the present invention on a full color Taxi Topper;

### DETAILED DESCRIPTION PREFERRED VERSIONS OF THE INVENTION

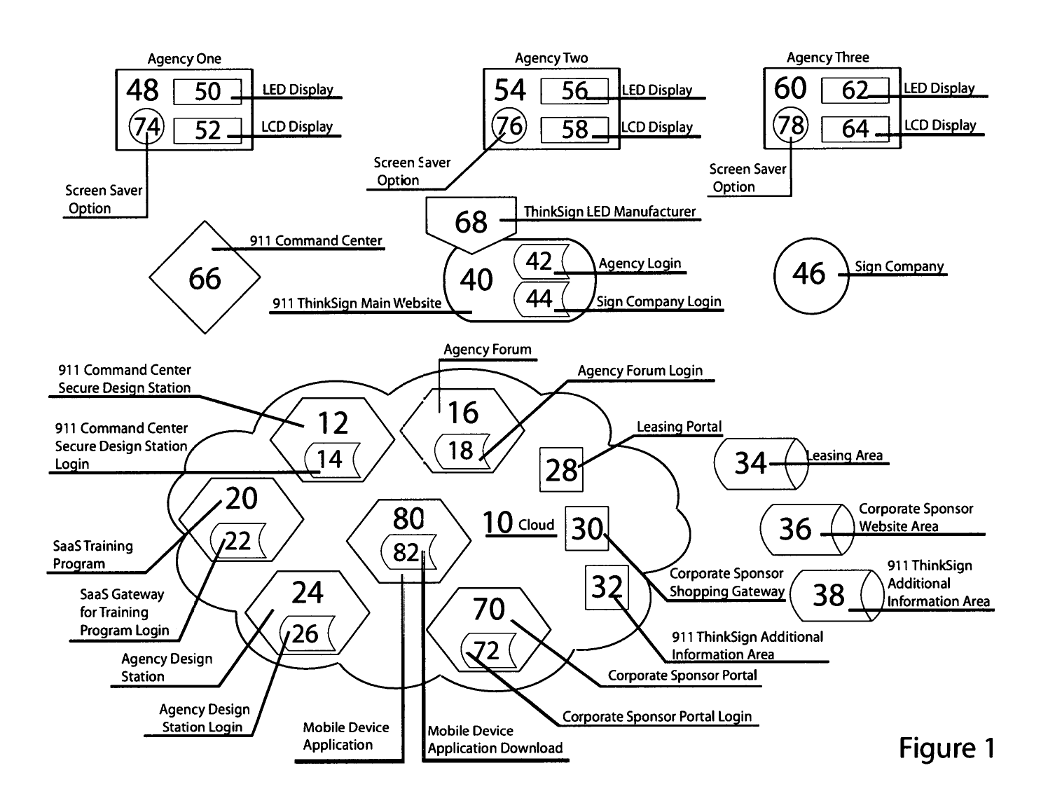

FIG. 1: Is an illustrative representation of a diagram of the Cloud 10. Within the Cloud 10 there are numbered symbols that represent key components. The key components are listed as: The 911 Command Center Secure Design Station 12, 911 Command Center Secure Design Station Login 14, Agency Forum 16, Agency Forum Login 18, SaaS Training Program 20, SaaS Gateway for Training Program(s) Login 22, Agency Design Station 24, Agency Design Station Login 26, Leasing Portal 28, Corporate Sponsor Shopping Gateway 30, Systems Additional Information 2 Portal 32, FEMA IPAWS OPEN 90.

The Leasing Area 34, Corporate Sponsor Shopping Gateway Access 36, Systems Additional Information Area 38, Systems Main Website 40, Agency Login 42, Distributors Login 44, Distributors 46, Agency One 48, Agency One Led Display 50 Access, Agency One LCD Display 52 Access, Agency Two 54, Agency Two LED Display 56 Access, Agency Two LCD Display 58 Access, Agency Three 60, Agency Three LED Display 62 Access, Agency Three LCD Display 64 Access, 911 Command Center 66, LED Manufacturing Company 68, Corporate Sponsor Portal 70, Corporate Sponsor Portal Login 72, Screen Saver Option (collectively; 74,76, and 78), Mobile Device Application 80 and Mobile Device Application Download 82, Vehicle Toppers 94.

The 911 aspects of the System can be implemented within other, for-profit areas (such as interior and exterior use in/for businesses and Malls) that could have a larger impact with getting important information to an area with a large traffic count. Furthermore, interior and/or exterior LED, LCD, Plasma and any other present or future display mediums can be identified within this document as LED Display and/or LCD Display.

The use of this system, once in place, will solve a problem that most Agencies have with the growing concern with budget cuts, diminishing grants and donations from the private sector. It will further help directing individual communities and their unique circumstances before, during and after emergency situations. It will help streamline many of their typical operations. The embodiment of FIG. 1 represents the system when in use.

Further: FIG. 1: Illustrates that the inclusion of the Licensing 46, and Roof Top Vehicle Displays 94.

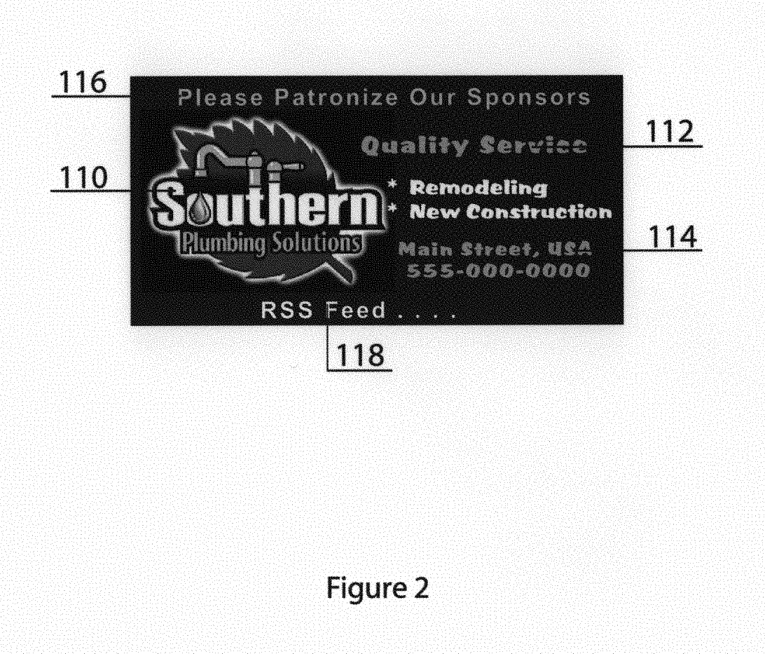

FIG. 2: Is an illustrative representation of a screen shot of how a typical Sponsor Screen will appear. The screen will show the Sponsor logo 210, the description of the business 212, contact information of the business 214, the saying ‘Please Support Our Sponsors’ 216. All texts and graphics are customizable. Also each screen is fully customizable upon unique or specialized criteria. This is for the use of fundraising within these Agencies from a previously untapped market. The embodiment of FIG. 2 represents the system when in use.

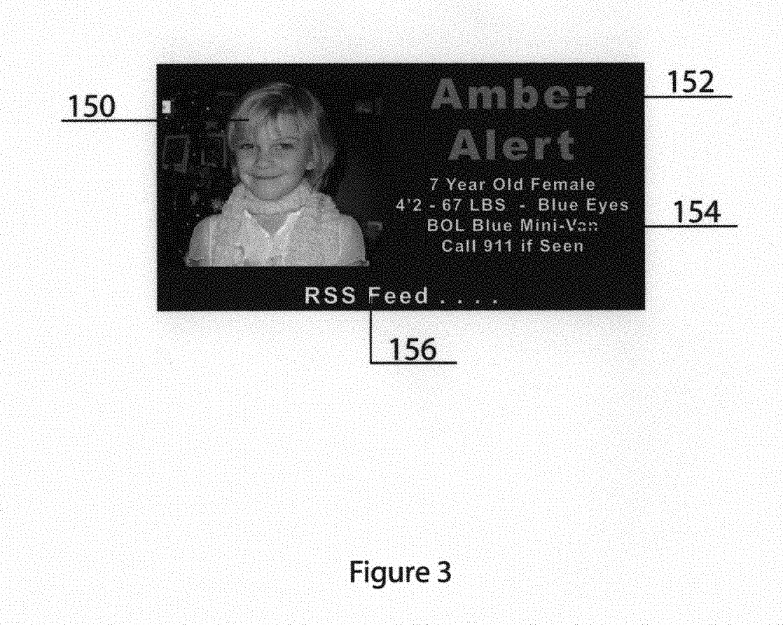

FIG. 3: Is an illustrative representation of a screen shot of how a typical Warning Screen will appear via FEMA's IPAWS OPEN 350. The screen will show the Alert, Warning or President's Message in an Amber color in straight text.

This will display according to the FEMA's IPAWS OPEN geographically targeted system. This will enable interoperability through many levels of approved government agencies; Federal, Regional, State, local, Tribal, and all other authorized users. This can be up on the designated Agencies sign instantaneously, and assists with enabling interoperability through the many levels of approved government agencies; Federal, Regional, State, local, and all other authorized users. The embodiment of FIG. 3 represents the system when in use.

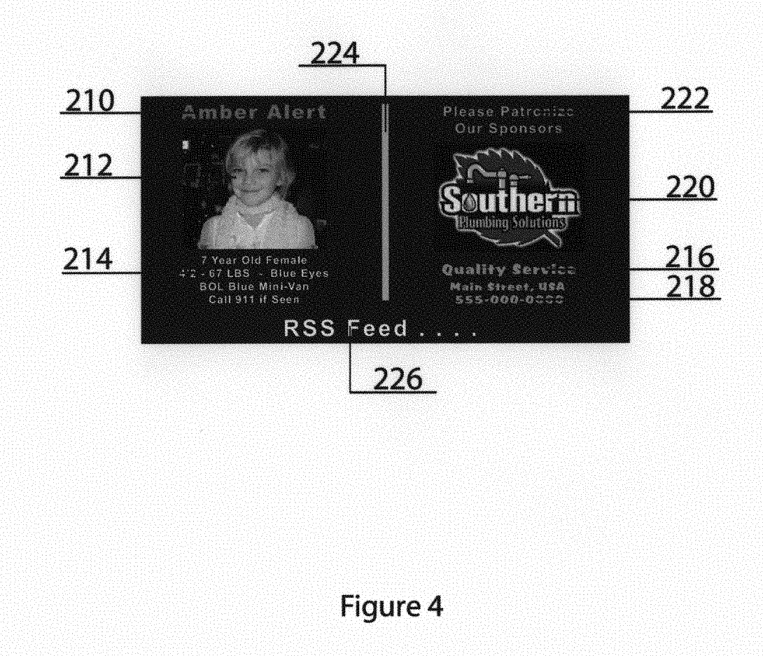

FIG. 4: Is an illustrative representation of a screen shot of how an Amber Alert screen will appear or other type of missing person such as SILVER Alerts, BOLO etc. . . . . The screen will show a picture of the missing person 450, Alert Title 452, the description of the missing person and other important information 454. This will be done using a feature in our system. All texts and graphics are customizable. This feature is also beneficial to use before, during and after emergency incidents to help protect life and property, and direct persons to safety, emergency shelters, and after disaster help. Also each screen is fully customizable upon unique or specialized criteria.

This can be up on the designated Agencies sign instantaneously, and assists with enabling interoperability through the many levels of approved government agencies; Federal, Regional, State, local, and all other authorized users. And is has the capability to override FEMA's IPAWS OPEN enabling local 911 Authorities to provide information and graphics otherwise not approved by FEMA's IPAWS OPEN guidelines other than the Presidents Message. The embodiment of FIG. 4 represents the system when in use.

Embodiments include having a full color LED Display, or future technology as such, that provides a means for Non-Profit 501C and Government Agencies to raise funds, and provide instantaneous geographically relevant graphic alerts and warnings to their communities, along with providing a more inclusive system for these organizations to use.

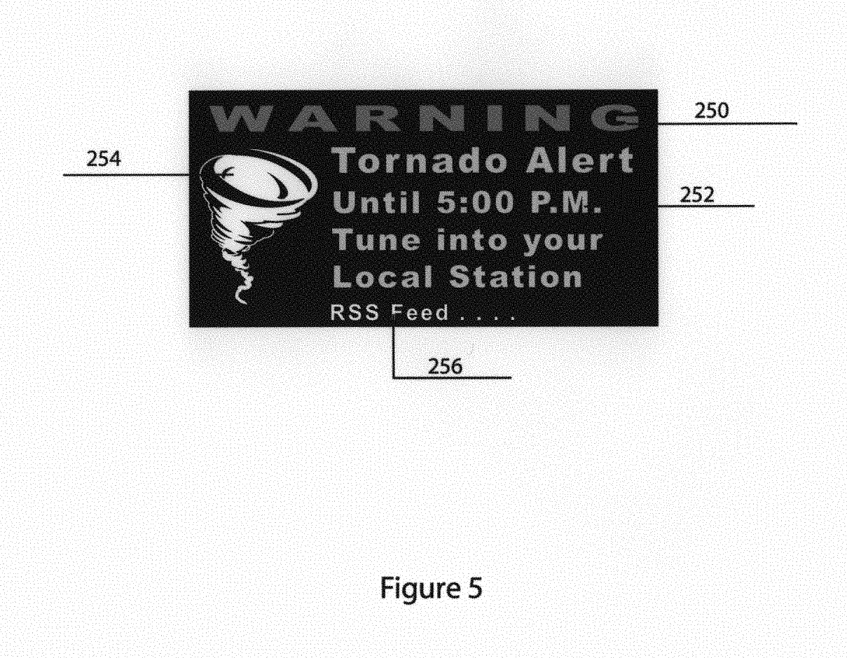

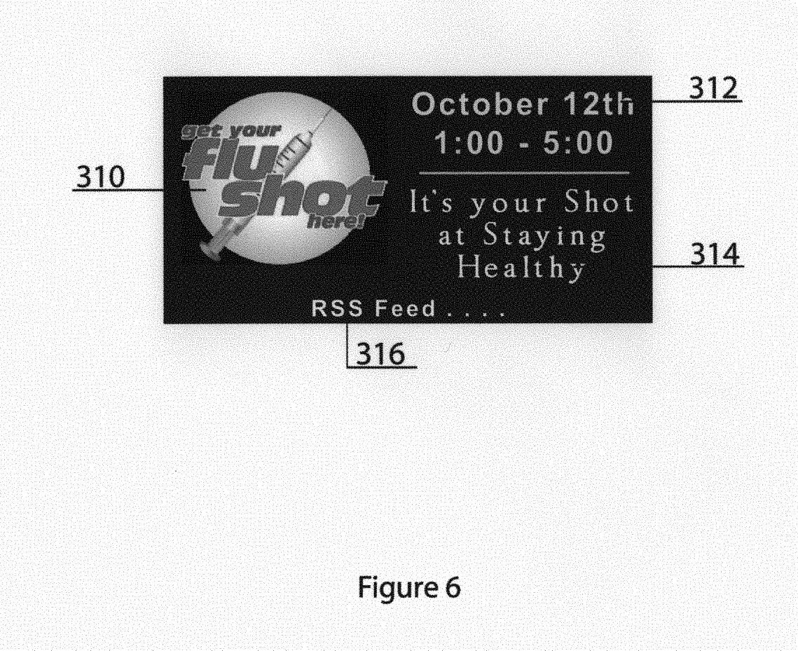

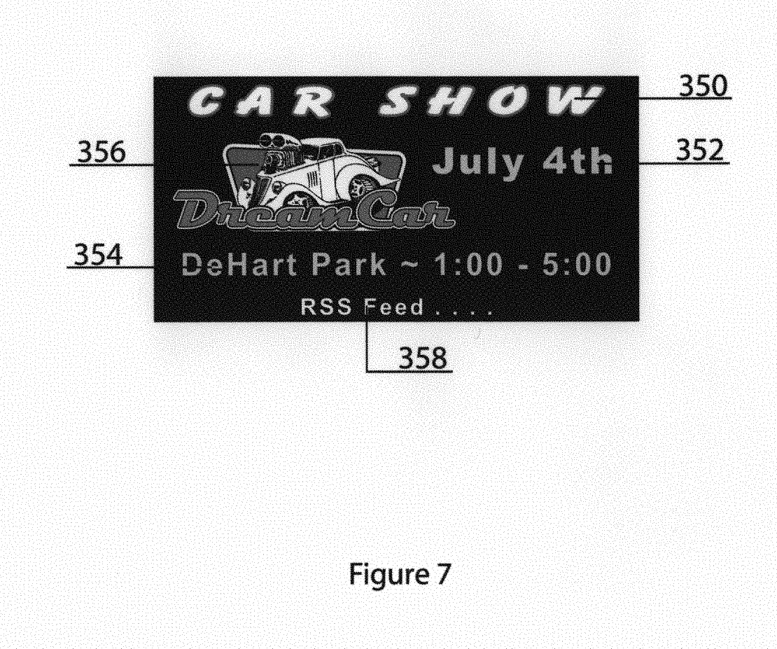

FIG. 5: Is an illustrative representation of a screen shot of how an Amber Alert screen will appear or other type of missing person such as SILVER Alerts, BOLO etc. . . . . The screen will show a picture of the missing person 550, Alert Title 552, the description of the missing person and other important information 554. This will be done using a feature in our system. All texts and graphics are customizable. This feature is also beneficial to use before, during and after emergency incidents to help protect life and property, and direct persons to safety, emergency shelters, and after disaster help. Also each screen is fully customizable upon unique or specialized criteria.

This can be up on the designated Agencies sign instantaneously, and assists with enabling interoperability through the many levels of approved government agencies; Federal, Regional, State, local, and all other authorized users. And is has the capability to override FEMA's IPAWS OPEN enabling local 911 Authorities to provide information and graphics otherwise not approved by FEMA's IPAWS OPEN guidelines other than the Presidents Message. The embodiment of FIG. 4 represents the system when in use.

Embodiments include having a full color LED Display, or future technology as such, that provides a means for Non-Profit 501C and Government Agencies to raise funds, and provide instantaneous geographically relevant graphic alerts and warnings to their communities, along with providing a more inclusive system for these organizations to use.

1. We have come up with a system utilizing a full color LED display to:
Provide away for Non-Profit 501C Organizations to receive a residual stream of donation from a previously untapped donation source.
Provide a way for Alerts and Warnings to be shown to small communities via FEMA' IPAWS
Provide a way for Local, State and Federal alerting authorities to over-ride FEMA's IPAWS to present more geographically relevant Alerts and Warnings, and with using full color images that will be beneficial during an AMBER Alert as an example.
We have further come up with a solution that will be both hardware based and software based.
Provide a way for data collection using a hardware beacon to ethically obtain data from passersby that will be able to formulate a more inclusive stream of information so that relevant statistics can be used to better prepare for emergency and disaster situations.
Provide a way for usage software data collection using surveys and behavior patterns to better improve the needs of the end users.
